(19) United States
(12) Patent Application Publication
(10) Pub. No.: US 2011/0175024 A1
(43) Pub. Date: Jul. 21, 2011

(54) METHOD FOR PRODUCING HIGH-PURITY SILICON CARBIDE FROM HYDROCARBONS AND SILICON OXIDE THROUGH CALCINATION

(76) Inventors: Juergen Erwin Lang, Karlsruhe (DE); Hartwig Rauleder, Rheinfelden (DE); Ekkehard Mueh, Rheinfelden (DE); Alfons Karl, Gruendau (DE)

(21) Appl. No.: 13/121,756

(22) PCT Filed: Sep. 28, 2009
(86) PCT No.: PCT/EP2009/062482

§ 371 Date: Mar. 30, 2011

(30) Foreign Application Priority Data
Sep. 30, 2008 (DE) 10 2008 042 499.4
Sep. 30, 2008 (DE) 10 2008 064 642.3

(51) Int. Cl. C09K 3/00; C01B 31/36

(52) U.S. Cl. 252/182.32; 423/345

(57) ABSTRACT

The invention relates to a method for producing silicon carbide through reaction of silicon oxide and a carbon source comprising a hydrocarbon at high temperature, in particular to a technical method for producing silicon carbide or for producing compositions containing silicon carbide. The invention further relates to a high-purity silicon carbide, to compositions containing the same, to the use thereof as a catalyst and for the production of electrodes and other items.

The invention relates to a process for preparing silicon carbide and/or silicon carbide-graphite particles by reaction of silicon oxide and a carbon source comprising a carbohydrate, in particular carbohydrates, at elevated temperature, in particular an industrial process for preparing silicon carbide or for preparing compositions containing silicon carbide and also the isolation of the reaction products. The invention further relates to a high-purity silicon carbide, compositions containing this, the use as catalyst and in the production of electrodes and other articles.

Silicon carbide has the trivial name carborundum. Silicon carbide is a chemical compound of silicon and carbon which belongs to the group of carbides and has the chemical formula SiC. Owing to its hardness and high melting point, silicon carbide is employed as abrasive (carborundum) and component of refractories. Large amounts of relatively impure SiC are used as metallurgical SiC for alloying of cast iron with silicon and carbon. It is also employed as insulator of fuel elements in high-temperature nuclear reactors or in heat-protection tiles in space flight. It likewise serves, in admixture with other materials, as aggregate for hard concrete in order to make industrial floors abrasion resistant. Rings of high-quality fishing rods are likewise made of SiC. In engineering ceramics, SiC is one of the most frequently used materials because of its widely useful properties, in particular because of its hardness.

Processes for preparing pure silicon carbide are generally known. Pure silicon carbide has hitherto been prepared industrially by the modified Lely method (J. A. Lely; Darstellung von Einkristallen von silicon carbide and Beherrschung von Art and Menge der eingebauten Verunreinigungen; Berichte der Deutschen Keramischen Gesellschaft e.V.; August 1955; pp. 229-231) or as described in US 2004/0231583 A1. Here, the HP gases monosilane (SiH₄) and propane (C₃H₈) are proposed as raw materials. These raw materials are expensive and difficult to handle.

In a further process, silicon carbide powder is obtained as beta-silicon carbide powder by gas-phase deposition from methylsilane using argon as carrier gas at from 1000 to be 1800° C. The content of metallurgical impurities, apart from further impurities, is said to be less than 1000 ppm (Verfahren zur Herstellung von Siliciumcarbidpulvern aus der Gasphase, W. Böcker et al., Ber. Dt. Keram. Ges., 55 (1978), No. 4, 233-237).

DE 25 18 950 teaches the preparation of silicon carbide by vapour-phase reaction of a mixture of silicon halide, a boron halide and a hydrocarbon such as toluene in a plasma jet reaction zone. The β-silicon carbide obtained has a boron content of from 0.2 to 1% by weight.

Disadvantages of the processes of the prior art are the high raw materials costs and/or the complicated handling of the hydrolysis-sensitive and/or spontaneously flammable raw materials for the preparation of pure silicon carbide.

Many of the present-day industrial applications of silicon carbide generally share very high purity requirements. For this reason, the impurity content of the silanes or halosilanes to be reacted must not exceed a few mg/kg (ppm range) and for later applications in the semiconductor industry must not exceed a few μg/kg (ppb range).

It was an object of the present invention to prepare high-purity silicon carbide from significantly cheaper raw materials and to overcome the abovementioned process disadvantages.

It has surprisingly been found that a high-purity silicon carbide in a carbon matrix and/or silicon carbide in a silicon dioxide matrix and/or a silicon carbide comprising carbon dioxide and/or silicon dioxide in a composition can be prepared inexpensively as a function of the mixing ratio by reaction of mixtures of silicon dioxide and sugar with subsequent pyrolysis and high-temperature calcination. The silicon carbide is preferably prepared in a carbon matrix. In particular, a silicon carbide particle having an exterior carbon matrix, preferably a graphite matrix on the inner and/or exterior surface of the particles, can be obtained. It can then be obtained in pure form in a simple manner by passive oxidation by means of air, in particular by the carbon being removed by oxidation. As an alternative, the silicon carbide can be further purified and/or deposited by sublimation at high temperatures and optionally in a high vacuum. Silicon carbide can be sublimated at temperatures of about 2800° C.

The object is achieved the process of the invention according to Claim 1 and by the composition according to Claims 11 and 12 and by the silicon carbide according to Claim 13. Preferred embodiments are described in the dependent claims and in the description.

According to the invention, the object is achieved by the process for preparing silicon carbide by reaction of silicon oxide, in particular silicon dioxide and/or silicon oxide, and a carbon source comprising a carbohydrate at elevated temperature, in particular by pyrolysis and calcination.

The invention provides a technical and industrial process for preparing silicon carbide. The reaction can be carried out at temperatures from 150° C. upwards, preferably from 400 to 3000° C., with it being possible to carry out a reaction at relatively low temperatures, in particular from 400 to 1400° C., in a first pyrolysis step (low-temperature mode) and a subsequent calcination at higher temperatures (high-temperature mode), in particular from 1400 to 3000° C., preferably from 1400 to 1800° C. The pyrolysis and calcination can be carried out directly in succession in one process or in two separate steps. For example, the process product of the pyrolysis can be packed as composition and later used by a further user to prepare silicon carbide or silicon.

As an alternative, the reaction of silicon oxide and the carbon source comprising a carbohydrate can commence in a low temperature range, for example from 150° C. upward, preferably at 400° C., and the temperature can be increased continuously or stepwise to, for example, 1800° C. or higher, in particular about 1900° C. This procedure can be advantageous for removal of the process gases formed.

In a further alternative method of carrying out the process, the reaction can be commenced straight off at high temperatures, in particular temperatures from >1400° C. to 3000° C., preferably from 1400° C. to 1800° C., particularly preferably from 1450 to less than about 1600° C. To suppress decomposition of the silicon carbide formed, the reaction is preferably carried out in an atmosphere which is low in oxygen at temperatures below the decomposition temperature, in particular below 1800° C., preferably below 1600° C. The process product which is isolated according to the invention is high-purity silicon carbide as per the following definition.

Silicon carbide can be obtained in pure form by after-treatment of the silicon carbide in a carbon matrix by passive oxidation by means of oxygen, air and/or NOₓ.H₂O, for example at temperatures of about 800° C. In this oxidation process, carbon or the carbon-containing matrix can be oxidized and removed from the system as process gas, for example as carbon monoxide. The purified silicon carbide may then still comprise one or more silicon oxide matrices or possibly small amounts of silicon.

The silicon carbide is relatively oxidation-resistant towards oxygen even at temperatures above 800° C. In direct contact with oxygen, it forms a passivating layer of silicon dioxide (SiO₂, “passive oxidation”). At temperatures above about 1600° C. and at the same time with a deficiency of oxygen (partial pressure below about 50 mbar), gaseous SiO is formed instead of the vitreous SiO₂; a protective effect is then no longer obtained and the SiC is quickly burnt (“active oxidation”). This active oxidation occurs when the free oxygen in the system has been consumed.

A C-based reaction product obtained according to the invention or a reaction product having a carbon matrix, in particular a pyrolysis product, contains carbon, in particular in the form of pyrolysis carbon and/or carbon black, and silica and also optionally proportions of other forms of carbon, e.g. graphite, and is particularly low in impurities, for example the elements boron, phosphorus, arsenic, iron and aluminium and also compounds thereof.

The pyrolysis and/or calcination product according to the invention can advantageously be used as reducing agent in the preparation of silicon carbide from sugar charcoal and silica at high temperature. In particular, the carbon- or graphite-containing pyrolysis and/or calcination product according to the invention can, owing to its conductive properties, be used for the production of electrodes, for example in an electric arc reactor, or as catalyst and raw material for the production of silicon, in particular for the production of solar silicon. The high-purity silicon carbide can likewise be used as energy source and/or as additive for the production of high-purity steels.

The present invention accordingly provides a process for preparing silicon carbide by reaction of silicon oxide, in particular silicon dioxide, and a carbon source comprising at least one carbohydrate at elevated temperature and, in particular, with the isolation of the silicon carbide. The invention also provides a silicon carbide or a composition containing silicon carbide which can be obtained by this process and also the pyrolysis and/or calcination product which can be obtained by the process of the invention, and also, in particular, the isolation thereof. The process of the invention is an industrial, preferably large-scale, process for the industrial reaction or industrial pyrolysis and/or calcination of a carbohydrate or carbohydrate mixture at elevated temperature with addition of silicon oxide and the associated materials conversion. In a particularly preferred process variant, the industrial process for preparing high-purity silicon carbide comprises the reaction of carbohydrates, if appropriate carbohydrate mixtures, with silicon oxide, in particular silicon dioxide, and silicon oxide formed in situ, at elevated temperature, in particular in the range from 400 to 3000° C., preferably from 1400 to 1800° C., particularly preferably from about 1450 to <about 1600° C.

According to the invention, a silicon carbide optionally together with a carbon matrix and/or silicon oxide matrix or a matrix comprising carbon and/or silicon oxide is isolated, in particular as product, optionally together with a content of silicon. The isolated silicon carbide can have any crystalline phase, for example α- or β-silicon carbide phase or mixtures of these or further silicon carbide phases. A total of more than 150 polytype phases are generally known for silicon carbide. The silicon carbide obtained by the process of the invention preferably contains only small amounts, if any, of silicon or is infiltrated with only a small proportion of silicon, in particular in the range from 0.001 to 60% by weight, preferably from 0.01 to 50% by weight, particularly preferably from 0.1 to 20% by weight, based on the silicon carbide including the abovementioned matrices and if appropriate silicon. According to the invention, there is generally no formation of silicon in the calcination or high-temperature reaction because no agglomeration of the particles and generally no formation of a melt occurs. Silicon would only be formed with formation of a melt. The further content of silicon can be controlled by infiltration with silicon.

For the purposes of the present invention, high-purity silicon carbide is a silicon carbide which, in addition to silicon carbide, may also contain carbon, in particular as C matrix, and/or silicon oxide such as Si_{y}O_{z} where y=1.0 to 20 and z=0.1 to 2.0, in particular as Si_{y}O_{z} matrix where y=1.0 to 20 and z=0.1 to 2.0, particularly preferably as SiO₂ matrix, and also possibly small amounts of silicon. For the purposes of the invention, high-purity silicon carbide is preferably a corresponding silicon carbide having a passivation layer comprising silicon dioxide. Likewise, high-purity silicon carbide is considered to be a high-purity composition containing or consisting of silicon carbide, carbon, silicon oxide and possibly small amounts of silicon, with the high-purity silicon carbide or the high-purity composition having, in particular, an impurity profile of boron and phosphorus of less than 100 ppm of boron, in particular from 10 ppm to 0.001 ppt, and less than 200 ppm of phosphorus, in particular from 20 ppm to 0.001 ppt of phosphorus; in particular, it has a total impurity profile of boron, phosphorus, arsenic, aluminium, iron, sodium, potassium, nickel and chromium of less than 100 ppm by weight, preferably less than 10 ppm by weight, particularly preferably less than 5 ppm by weight, based on the high-purity total composition or the high-purity silicon carbide.

The impurity profile of the high-purity silicon carbides in respect of boron, phosphorus, arsenic, aluminium, iron, sodium, potassium, nickel and chromium is preferably from <5 ppm to 0.01 ppt (by weight), in particular from <2.5 ppm to 0.1 ppt, for each element. The silicon carbide, optionally together with carbon and/or Si_{y}O_{z} matrices, obtained by the process of the invention particularly preferably has the following impurity content:

boron less than 100 ppm, preferably in the range from 10 ppm to 0.001 ppt, particularly preferably from 5 ppm to 0.001 ppt or from <0.5 ppm to 0.001 ppt, and/or
phosphorus less than 200 ppm, preferably in the range from 20 ppm to 0.001 ppt, particularly preferably from 5 ppm to 0.001 ppt or from <0.5 ppm to 0.001 ppt, and/or
sodium less than 100 ppm, preferably in the range from 10 ppm to 0.001 ppt, particularly preferably from 5 ppm to 0.001 ppt or from <1 ppm to 0.001 ppt, and/or
aluminium less than 100 ppm, preferably in the range from 10 ppm to 0.001 ppt, particularly preferably from 5 ppm to 0.001 ppt or from <1 ppm to 0.001 ppt, and/or
iron less than 100 ppm, preferably in the range from 10 ppm to 0.001 ppt, particularly preferably from 5 ppm to 0.001 ppt or from <0.5 ppm to 0.001 ppt, and/or
chromium less than 100 ppm, preferably in the range from 10 ppm to 0.001 ppt, particularly preferably from 5 ppm to 0.001 ppt or from <0.5 ppm to 0.001 ppt, and/or
nickel less than 100 ppm, preferably in the range from 10 ppm to 0.001 ppt, particularly preferably from 5 ppm to 0.001 ppt or from <0.5 ppm to 0.001 ppt, and/or
potassium less than 100 ppm, preferably in the range from 10 ppm to 0.001 ppt, particularly preferably from 5 ppm to 0.001 ppt or from <0.5 ppm to 0.001 ppt, and/or
sulphur less than 100 ppm, preferably in the range from 10 ppm to 0.001 ppt, particularly preferably from 5 ppm to 0.001 ppt or from <2 ppm to 0.001 ppt, and/or
barium less than 100 ppm, preferably in the range from 10 ppm to 0.001 ppt, particularly preferably from 5 ppm to 0.001 ppt or from <3 ppm to 0.001 ppt, and/or
zinc less than 100 ppm, preferably in the range from 10 ppm to 0.001 ppt, particularly preferably from 5 ppm to 0.001 ppt or from <0.5 ppm to 0.001 ppt, and/or
zirconium less than 100 ppm, preferably in the range from 10 ppm to 0.001 ppt, particularly preferably from 5 ppm to 0.001 ppt or from <0.5 ppm to 0.001 ppt, and/or
titanium less than 100 ppm, preferably in the range from 10 ppm to 0.001 ppt, particularly preferably from 5 ppm to 0.001 ppt or from <0.5 ppm to 0.001 ppt, and/or
calcium less than 100 ppm, preferably in the range from 10 ppm to 0.001 ppt, particularly preferably from 5 ppm to 0.001 ppt or from <0.5 ppm to 0.001 ppt, and
in particular magnesium at less than 100 ppm, preferably in the range from 10 ppm to 0.001 ppt, particularly preferably in the range from 11 ppm to 0.001 ppt, and/or copper less than 100 ppm, preferably in the range from 10 ppm to 0.001 ppt, particularly preferably in the range from 2 ppm to 0.001 ppt, and/or cobalt less than 100 ppm, in particular in the range from 10 ppm to 0.001 ppt, particularly preferably in the range from 2 ppm to 0.001 ppt, and/or vanadium less than 100 ppm, in particular in the range from 10 ppm to 0.001 ppt, preferably in the range from 2 ppm to 0.001 ppt, and/or manganese less than 100 ppm, in particular in the range from 10 ppm to 0.001 ppt, preferably in the range from 2 ppm to 0.001 ppt, and/or lead less than 100 ppm, in particular in the range from 20 ppm to 0.001 ppt, preferably in the range from 10 ppm to 0.001 ppt, particularly preferably in the range from 5 ppm to 0.001 ppt.

A particularly preferred high-purity silicon carbide or high-purity composition contains or consists of silicon carbide, carbon, silicon oxide and possibly small amounts of silicon, with the high-purity silicon carbide or the high-purity composition having, in particular, an impurity profile in respect of boron, phosphorus, arsenic, aluminium, iron, sodium, potassium, nickel, chromium, sulphur, barium, zirconium, zinc, titanium, calcium, magnesium, copper, chromium, cobalt, zinc, vanadium, manganese and/or lead of less than 100 ppm, preferably from <20 ppm to 0.001 ppt, particularly preferably in the range from 10 ppm to 0.001 ppt, based on the high-purity total composition or the high-purity silicon carbide.

These high-purity silicon carbides or high-purity compositions can be obtained by using the reaction participants, viz. the carbohydrate-containing carbon source and the silicon oxide used, and also the reactors, reactor components, pipes, storage vessels for the reactants, the reactor lining, cladding and any added reaction gases or inert gases having the necessary purity in the process of the invention.

The high-purity silicon carbide or the high-purity composition according to the above definition, in particular comprising a content of carbon; for example in the form of pyrolysis carbon, carbon black, graphite; and/or silicon oxide, in particular in the form of SiO₂, has an impurity profile in respect of boron and/or phosphorus or compounds containing boron and/or phosphorus which is preferably less than 100 ppm, in particular in the range from 10 ppm to 0.001 ppt, for the element boron and less than 200 ppm, in particular in the range from 20 ppm to 0.001 ppt, for phosphorus. The boron content of a silicon carbide is preferably in the range from 7 ppm to 1 ppt, preferably in the range from 6 ppm to 1 ppt, particularly preferably in the range from 5 ppm to 1 ppt or less, or, for example, in the range from 0.001 ppm to 0.001 ppt, preferably in the region of the analytical detection limit. The phosphorus content of a silicon carbide should preferably be in the range from 18 ppm to 1 ppt, preferably in the range from 15 ppm to 1 ppt, particularly preferably in the range from 10 ppm to 1 ppt or less. The phosphorus content is preferably in the region of the analytical detection limit. The proportions ppm, ppb and/or ppt are always by weight, in particular in mg/kg, μg/kg, ng/kg or in mg/g, μg/g or ng/g, etc.

The actual pyrolysis (low-temperature step) generally takes place at temperatures below about 800° C. The pyrolysis can be carried out at atmospheric pressure, under reduced pressure or under superatmospheric pressure, depending on the desired product. If it is carried out under reduced pressure or low pressure, the process gases can readily be taken off and highly porous, particulate structures are usually obtained after the pyrolysis. Under conditions in the region of atmospheric pressure, the porous, particulate structures are usually agglomerated to a greater extent. If the pyrolysis is carried out under superatmospheric pressures, the volatile reaction products can condense on the silicon oxide particles and may react with themselves or with reactive groups of the silicon dioxide. Thus, for example, decomposition products of the carbohydrates, e.g. ketones, aldehydes or alcohols, can react with free hydroxy groups of the silicon dioxide particles. This significantly reduces pollution of the environment with process gases. The porous pyrolysis products obtained are in this case agglomerated to a somewhat greater extent. Apart from pressure and temperature, which can be selected freely within wide limits as a function of the desired pyrolysis product and their precise matching to one another is known per se to those skilled in the art, the pyrolysis of the carbon source containing at least one carbohydrate can be carried out in the presence of moisture, in particular residual moisture of the starting materials, or with introduction of moisture in the form of condensed water, water vapour or hydrate-containing components, e.g. SiO₂.nH₂O or other hydrates with which those skilled in the art are familiar. The presence of moisture has, in particular, the effect that the carbohydrate is more readily pyrolysed and that complicated predrying of the starting materials can be dispensed with. The process for preparing silicon carbide by reaction of silicon oxide and a carbon source comprising at least one carbohydrate at elevated temperature, in particular at the beginning of the pyrolysis, is particularly preferably carried out in the presence of moisture; if appropriate, moisture is also present or is introduced during the pyrolysis.

The calcination step (high-temperature step) generally immediately follows the pyrolysis, but it can also be carried out at a later point in time, for example when the pyrolysis product is sold on. The temperature ranges of the pyrolysis and calcination steps may overlap somewhat. The calcination is usually carried out at from 1400 to 2000° C., preferably from 1400 to 1800° C. If the pyrolysis is carried out at temperatures below 800° C., the calcination step can also extend to a temperature range from 800° C. to about 1800° C. To achieve improved heat transfer, high-purity silicon oxide spheres, in particular fumed silica spheres and/or silicon carbide spheres, or fumed silica and/or silicon carbide particles in general can be used in the process. These heat transfer agents are preferably used in rotary tube furnaces or in microwave furnaces. In microwave furnaces, the microwaves are injected into the fumed silica particles and/or silicon carbide particles so that the particles heat up. The spheres and/or particles are preferably well distributed in the reaction system so as to make uniform heat transfer possible.

The impurities in the respective starting materials and process products are determined by means of sample decomposition methods known to those skilled in the art, for example by detection by ICP-MS (analysis for the determination of trace impurities).

As carbon source comprising at least one carbohydrate, use is made, according to the invention, of carbohydrates or saccharides or mixtures of carbohydrates or suitable derivatives of carbohydrates in the process of the invention. It is possible to use naturally occurring carbohydrates, anomers of these, invert sugar and also synthetic carbohydrates. Carbohydrates which have been obtained biotechnologically, for example by means of fermentation, can likewise be used. The carbohydrate or derivative is preferably selected from among a monosaccharide, disaccharide, oligosaccharide and polysaccharide and mixtures of at least two of the saccharides mentioned. The following carbohydrates are particularly preferably used in the process: monosaccharides, i.e. aldoses or ketoses such as trioses, tetroses, pentoses, hexoses, heptoses, in particular glucose or fructose, and also corresponding oligosaccharides and polysaccharides based on said monomers, e.g. lactose, maltose, sucrose, raffinose, to name only a few, and derivatives of the carbohydrates mentioned can likewise be used as long as they meet the abovementioned purity requirements, through to cellulose, cellulose derivatives, starch, including amylose and amylopectin, the glycogens, the glycosans and fructosans, to name only a few polysaccharides. However, it is also possible to use a mixture at least two of the above-mentioned carbohydrates as carbohydrate or carbohydrate component in the process of the invention. It is generally possible to use all carbohydrates, derivatives of carbohydrates and carbohydrate mixtures in the process of the invention, preferably ones having a sufficient purity, in particular in respect of the elements boron, phosphorus and/or aluminium. The total amount of the elements mentioned present as impurities in the carbohydrate or the mixture should be less than 100 μg/g, in particular from <100 μg/g to 0.0001 μg/g, preferably from <10 μg/g to 0.001 μg/g, particularly preferably from <5 μg/g to 0.01 μg/g. The carbohydrates to be used according to the invention comprise the elements carbon, hydrogen, oxygen and may have the impurity profile mentioned.

Carbohydrates comprising the elements carbon, hydrogen, oxygen and nitrogen, possibly having the impurity profile mentioned, can also advantageously be used in the process if a doped silicon carbide or a silicon carbide containing proportions of silicon nitride is to be prepared. To prepare silicon carbide containing proportions of silicon nitride, in which case the silicon nitride does not count as impurity, chitin can advantageously also be used in the process.

Further carbohydrates which can be obtained on an industrial scale are lactose, hydroxypropylmethylcellulose (HPMC) and further customary tableting aids which may, if appropriate, be used for formulation of the silicon oxide with customary crystalline sugars.

Particular preference is given to using a crystalline sugar which is available in economic amounts, viz. a sugar as can be obtained, for example, in a manner known per se by crystallization of a solution or a juice from sugar cane or sugar beet, i.e. commercial crystalline sugar, in particular food-grade crystalline sugar, in the process of the invention. The sugar or the carbohydrate can, if the impurity profile is suitable for the process, naturally generally also be used in liquid form as syrup, in the solid state, i.e. also amorphous, in the process. A formulation and/or drying step is then carried out beforehand if appropriate.

The sugar can also have been prepurified in the liquid phase, if appropriate in demineralized water or another suitable solvent or solvent mixture, by means of ion exchangers in order to remove any specific impurities which can less readily be separated off by crystallization. Possible ion exchangers are strongly acidic, weakly acidic, amphoteric, neutral or basic ion exchangers. The choice of the correct ion exchanger is known per se to those skilled in the art as a function of the impurities to be separated off. The sugar can subsequently be crystallized, centrifuged and/or dried or mixed with silicon oxide and dried. The crystallization can be effected by cooling or addition of an antisolvent or other methods with which those skilled in the art are familiar. The crystalline material can be separated off by means of filtration and/or centrifugation.

According to the invention, the carbon source containing at least one carbohydrate or the carbohydrate mixture has the following impurity profile: boron less than 2 [μg/g], phosphorus less than 0.5 [μg/g] and aluminium less than 2 [μg/g], preferably less than or equal to 1 [μg/g], in particular iron less than 60 [μg/g]; the content of iron is preferably less than 10 [μg/g], particularly preferably less than 5 [μg/g]. Overall, efforts are made according to the invention to use carbohydrates in which the contents of impurities such as boron, phosphorus, aluminium and/or arsenic etc., are below the industrially possible detection limit in each case.

The carbohydrate source comprising at least one carbohydrate, according to the invention the carbohydrate or the carbohydrate mixture, preferably has the following purity profile in respect of boron, phosphorus and aluminium and also, if appropriate, of iron, sodium, potassium, nickel and/or chromium. The contamination with boron (B) is, in particular, in the range from 5 to 0.000001 μg/g, preferably from 3 to 0.00001 μg/g, particularly preferably from 2 to 0.00001 μg/g, according to the invention from <2 to 0.00001 μg/g. The contamination with phosphorus (P) is, in particular, in the range from 5 to 0.000001 μg/g, preferably from 3 to 0.00001 μg/g, particularly preferably from <1 to 0.00001 μg/g, according to the invention from <0.5 to 0.00001 μg/g. The contamination with iron (Fe) is in the range from 100 to 0.000001 μg/g, in particular in the range from 55 to 0.00001 μg/g, preferably from 2 to 0.00001 μg/g, particularly preferably from 1 to 0.00001 μg/g, according to the invention from <0.5 to 0.00001 μg/g. The contamination with sodium (Na) is, in particular, in the range from 20 to 0.000001 μg/g, preferably from 15 to 0.00001 μg/g, particularly preferably from <12 to 0.00001 μg/g, according to the invention from <10 to 0.00001 μg/g. The contamination with potassium (K) is, in particular, in the range from 30 to 0.000001 μg/g, preferably from 25 to 0.00001 μg/g, particularly preferably from <20 to 0.00001 μg/g, according to the invention from <16 to 0.00001 μg/g. The contamination with aluminium (Al) is, in particular, in the range from 4 to 0.000001 μg/g, preferably from 3 to 0.00001 μg/g, particularly preferably from <2 to 0.00001 μg/g, according to the invention from <1.5 to 0.00001 μg/g. The contamination with nickel (Ni) is, in particular, in the range from 4 to 0.000001 μg/g, preferably from 3 to 0.00001 μg/g, particularly preferably from <2 to 0.00001 μg/g, according to the invention from <1.5 to 0.00001 μg/g. The contamination with chromium (Cr) is, in particular, in the range from 4 to 0.000001 μg/g, preferably from 3 to 0.00001 μg/g, particularly preferably from <2 to 0.00001 μg/g, according to the invention from <1 to 0.00001 μg/g.

According to the invention, a crystalline sugar, for example refined sugar, is used or a crystalline sugar is mixed with a water-containing silicon dioxide or a silica sol, dried and used in particulate form in the process. As an alternative, any desired carbohydrate, in particular sugar, invert sugar or syrup, can be mixed with a dry, water-containing or aqueous silicon oxide, silicon dioxide, a silica acid having a water content or a silica sol or the silicon oxide components mentioned below, if appropriate dried and used as particles, preferably particles having a particle size of from 1 nm to 10 mm, in the process.

It is usual to use sugar having an average particle size of from 1 nm to 10 cm, in particular from 10 μm to 1 cm, preferably from 100 μm to 0.5 cm. As an alternative, sugar having an average particle size in the micron to millimetre range can be used, with preference being given to the range from 1 micron to 1 mm, particularly preferably from 10 microns to 100 microns. The particle size can be determined, inter alia, by means of sieve analysis, TEM (transmission electron microscopy), SEM (scanning electron microscopy) or optical microscopy. It is also possible to use a dissolved carbohydrate as liquid, syrup or paste, with the high-purity solvent evaporating before pyrolysis. As an alternative, a drying step can be carried out beforehand to recover the solvent.

Further preferred raw materials as carbon source are all organic compounds known to those skilled in the art which comprise at least one carbohydrate and satisfy the purity requirements, for example solutions of carbohydrates. As carbohydrate solution, it is also possible to use an aqueous-alcoholic solution or a solution containing tetraethoxy-silane (Dynasylan® TEOS) or a tetraalkoxysilane, with the solution evaporating before the actual pyrolysis and/or being pyrolysed.

As silicon oxide or silicon oxide component, preference is given to using an SiO, particularly preferably an SiO where x=0.5 to 1.5, SiO, SiO₂, silicon oxide (hydrate), aqueous or water-containing SiO₂, a silicon oxide in the form of pyrogenic or precipitated silica, moist, dry or calcined, for example Aerosil® or Sipernat®, or a silica sol or gel, porous or dense fused silica, silica sand, fused silica fibres, for example optical fibres, fused silica beads or mixtures of at least two of the above-mentioned forms of silicon oxide. The particle sizes of the individual components are matched to one another in a manner known to those skilled in the art.

For the purposes of the present invention, a sol is a colloidal solution in which the solid or liquid material is very finely dispersed in a solid, liquid or gaseous medium (see also Römpp Chemie Lexikon).

The particle size of the carbon source comprising a carbohydrate and also the particle size of the silicon oxide are, in particular, matched to one another so as to make good homogenization of the components possible and prevent demixing before or during the process.

Preference is given to using a porous silica, in particular a porous silica having an internal surface area of from 0.1 to 800 m²/g, preferably from 10 to 500 m²/g or from 100 to 200 m²/g, and in particular having an average particle size of 1 nm or greater or else from 10 nm to 10 mm, in particular silica having a high (99.9%) to very high (99.9999%) purity, with the total content of impurities such as B, P, As and Al impurities advantageously being less than 10 ppm by weight, based on the total composition. The purity is determined by sample decomposition known to those skilled in the art, for example by detection by ICP-MS (analysis for determining trace impurities). A particularly sensitive detection can be achieved by electron spin spectrometry. The internal surface area can, for example, be determined by the BET method (DIN ISO 9277, 1995).

A preferred average particle size of the silicon oxide is in the range from 10 nm to 1 mm, in particular from 1 to 500 μm. The particle size can be determined, inter alia, by means of TEM (transmission electron microscopy), SEM (scanning electron-microscopy) or optical microscopy.

Suitable silicon oxides are generally all silicon oxide-containing compounds and/or minerals which have a purity suitable for the process and thus for the process product and do not introduce any elements and/or compounds into the process which interfere or do not burn out without leaving a residue into the process. As indicated above, pure or highly pure silicon oxide-containing compounds or materials are used in the process.

When the various silicon oxides, in particular the various silicas, silicic acids, etc., are used, agglomeration can occur differently during the pyrolysis depending on the pH of the particle surface. In general, increased agglomeration of the particles due to pyrolysis is observed in the case of more acidic silicon oxides. It can therefore be preferred to use silicon oxides having neutral to basic surfaces, for example having pH values in the range from 7 to 14, when pyrolysis and/or calcination products having little agglomeration are to be prepared.

According to the invention, silicon oxide encompasses a silicon dioxide, in particular a pyrogenic or precipitated silica, preferably a pyrogenic or precipitated silica having a high or very high purity. For the purposes of the invention, a silicon oxide having a very high purity is a silicon oxide, in particular a silicon dioxide, in which the contamination of the silicon oxide with boron and/or phosphorus or compounds containing boron and/or phosphorus should be less than 10 ppm, in particular in the range from 10 ppm to 0.001 ppt, for boron and less 20 ppm, in particular in the range from 20 ppm to 0.001 ppt, for phosphorus. The boron content is preferably in the range from 7 ppm to 1 ppt, preferably in the range from 6 ppm to 1 ppt, particularly preferably in the range from 5 ppm to 1 ppt or below, or, for example, in the range from 0.001 ppm to 0.001 ppt, preferably in the region of the analytical detection limit. The phosphorus content of the silicon oxides should preferably be in the range from 18 ppm to 1 ppt, preferably in the range from 15 ppm to 1 ppt, particularly preferably in the range from 10 ppm to 1 ppt or below. The phosphorus content is preferably in the region of the analytical detection limit.

Silicon oxides such as quartz, quartzite and/or silicon dioxides prepared in a conventional manner are also advantageous. These can be the silicon dioxides occurring in crystalline modifications, e.g. moganite (chalcedony), α-quartz (low quartz), 13-quartz (high quartz), tridymite, cristobalite, coesite, stishovite, or amorphous SiO₂, particularly when they satisfy the abovementioned purity requirements. Furthermore, preference can be given to using silicas, in particular precipitated silicas or silica gels, pyrogenic SiO₂, pyrogenic silica in the process and/or the composition. Conventional pyrogenic silicas are amorphous SiO₂ powders having an average diameter of from 5 to 50 nm and a specific surface area of from 50 to 600 m²/g. The above listing is not to be considered conclusive, and it will be clear to a person skilled in the art that it is also possible to use other suitable silicon oxide sources in the process if the silicon oxide source has an appropriate purity, if appropriate after purification.

The silicon oxide, in particular SiO₂, can be provided and/or used in pulverulent, granular, porous or foamed form, as extrudate, as compact and/or as porous vitreous body, if appropriate together with further additives, in particular together with the carbon source comprising at least one carbohydrate and, if appropriate, a binder and/or shaping aid.

Preference is given to using a pulverulent, porous silicon dioxide as shaped body, in particular as extrudate or compact, particularly preferably together with the carbon source comprising a carbohydrate in an extrudate or compact, for example in a pellet or briquette. In general, all solid reactants such as silicon dioxide and if appropriate the carbon source comprising at least one carbohydrate should be used in the process in a form or be present in a composition which offers the greatest possible surface area for the reaction. In addition, an elevated porosity is desirable for rapid removal of the process gases. It is therefore possible, according to the invention, to use a particulate mixture of silicon dioxide particles having a coating/surface layer of carbohydrate. This particulate mixture is, in a particularly preferred embodiment, present as a composition or as a kit, in particular prepackaged.

The amounts of starting materials and also the respective ratios of silicon oxide, in particular silicon dioxide, to the carbon source comprising at least one carbohydrate depend on the circumstances or requirements known to those skilled in the art, for example in a subsequent process for silicon production, sintering processes, processes for producing electrode material or electrodes.

In the process of the invention, the carbohydrate can be used in a weight ratio of carbohydrate to silicon oxide, in particular silicon dioxide, of from 1000:0.1 to 1:1000, based on the total weight. The carbohydrate or carbohydrate mixture is preferably used in a weight ratio to silicon oxide, in particular silicon dioxide, of from 100:1 to 1:100, particularly preferably from 50:1 to 1:5, very particularly preferably from 20:1 to 1:2, with a preferred range from 2:1 to 1:1. In a preferred variant, carbon is used via the carbohydrate in an excess over the silicon in the silicon oxide to be reacted in the process. If the silicon oxide is, in an advantageous embodiment, used in excess, it should be ensured that the formation of silicon carbide is not suppressed when choosing the ratio.

Likewise according to the invention, the molar ratio of the content of carbon from the carbon source comprising a carbohydrate to the silicon content of the silicon oxide, in particular silicon dioxide, is from 1000:0.1 to 0.1:1000 based on the total composition. When conventional crystalline sugars are used, the preferred range of mole of carbon introduced via the carbon source comprising a carbohydrate to mole of silicon introduced via the silicon oxide compound is from 100 mol:1 mol to 1 mol:100 mol (C:Si in the starting materials), and the C:Si ratio is particularly preferably from 50:1 to 1:50, very particularly preferably from 20:1 to 1:20, according to the invention in the range from 3:1 to 2:1 or down to 1:1. Preference is given to molar ratios at which the carbon from the carbon source is introduced in an approximately equimolar amount or in excess relative to the silicon in the silicon oxide.

The process usually comprises a plurality of stages. In a first process step, the carbon source comprising at least one carbohydrate is pyrolysed in the presence of silicon oxide with graphitization; in particular, carbon-containing pyrolysis products, for example coatings containing proportions of graphite and/or carbon black, are formed on or in the silicon oxide component such as SiOx where x=0.5 to 1.5, SiO, SiO₂, silicon oxide (hydrate). The pyrolysis is followed by the calcination. The pyrolysis and/or calcination can be carried out one after the other in a reactor or separately in different reactors. For example, the pyrolysis is carried out in a first reactor and the subsequent calcination is carried out, for example, in a microwave furnace having a fluidized bed. A person skilled in the art will know that the reactor structures, vessels, feed and/or discharge lines, furnace structures must themselves not contribute to contamination of the process product.

The process is generally carried out with the silicon oxide and the carbon source comprising at least one carbohydrate being intimately mixed, dispersed homogenized or present in a formulation being fed to a first reactor for the pyrolysis. This can be effected continuously or batchwise. If appropriate, the starting materials are dried before being fed into the actual reactor; adhering water or the residual moisture can preferably remain in the system. The overall process is divided into a first phase in which the pyrolysis occurs and a further phase in which the calcination takes place.

The pyrolysis is generally carried out, particularly at the at least one first reactor, in the low-temperature mode at about 700° C., usually in the range from 200° C. to 1600° C., particularly preferably in the range from 300° C. to 1500° C., in particular at from 400 to 1400° C., with a graphite-containing pyrolysis product preferably being obtained. The internal temperature of the reaction participants is preferably considered to be the pyrolysis temperature. The pyrolysis product is preferably obtained at temperatures of from about 1300 to 1500° C.

The process is generally operated in the low-pressure range and/or under an inert gas atmosphere. As inert gas, preference is given to argon or helium. Nitrogen can likewise be advantageous, or when, if appropriate, silicon nitride is to be formed in addition to silicon carbide or n-doped silicon carbide is to be formed in the calcination step, which can be desirable depending on the process variant. To produce n-doped silicon carbide in the calcination step, nitrogen can be introduced into the process in the pyrolysis and/or calcination step, if appropriate via the carbohydrates such as chitin. It can likewise be advantageous to prepare specifically p-doped silicon carbide, and in this specific exception the aluminium content, for example, can be higher. Doping can be effected by means of aluminium-containing substances, for example via trimethyl-aluminium gas.

Depending on the pressure in the reactor, pyrolysis products or compositions having different degrees of agglomeration and different porosities can be produced in this process step. In general, less agglomerated pyrolysis products having an increased porosity are obtained under reduced pressure than under atmospheric pressure or superatmospheric pressure.

The pyrolysis time can be in the range from 1 minute to usually 48 hours, in particular in the range from 15 minutes to 18 hours, preferably from 30 minutes to about 12 hours, at the abovementioned pyrolysis temperatures. The heating phase up to the pyrolysis temperature generally has to be added here.

The pressure range is usually from 1 mbar to 50 bar, in particular from 1 mbar to 10 bar, preferably from 1 mbar to 5 bar. Depending on the desired pyrolysis product and to minimize the formation of carbon-containing process gases, the pyrolysis step of the process can also be carried out in a pressure range from 1 to 50 bar, preferably from 2 to 50 bar, particularly preferably from 5 to 50 bar. A person skilled in the art will know that the pressure to be selected is a compromise between removal of gas, agglomeration and reduction of the carbon-containing process gases.

The pyrolysis of the reaction participants, e.g. silicon oxide and the carbohydrate, is followed by the calcination step. In this, the pyrolysis products are converted further into silicon carbide and evaporation of water of crystallization and sintering of the process products may take place. The calcination or the high-temperature part of the process is usually carried out in the pressure range from 1 mbar to 50 bar, in particular from 1 mbar to 1 bar (ambient pressure), in particular from 1 to 250 mbar, preferably from 1 to 10 mbar. As inert gas atmosphere, it is possible to use that mentioned above. The calcination time depends on the temperature and the reactants used. In general, it is in the range from 1 minute to usually 48 hours, in particular in the range from 15 minutes to 18 hours, preferably in the range from 30 minutes to about 12 hours, at the calcination temperatures mentioned. The heating phase to the calcination temperature generally has to be added here.

The conversion into silicon carbide at elevated temperature, in particular the calcination step, is preferably carried out at a temperature of from 400 to 3000° C.; the calcination is preferably carried out in the high-temperature range from 1400 to 3000° C., preferably from 1400° C. to 1800° C., particularly preferably in the range from 1450 or 1500 to 1700° C. The temperature ranges are not restricted to those disclosed since the temperatures reached depend directly on the reactors used. The temperature figures given are based on measurements using standard high-temperature temperature sensors, for example encapsulated PtRhPt elements or alternatively via the colour temperature using optical comparison with an incandescent coil.

For the purposes of the present invention, a calcination (high-temperature range) is therefore a section of the process in which the reaction participants react essentially to form high-purity silicon carbide, optionally containing a carbon matrix and/or a silicon oxide matrix and/or mixtures of these.

The reaction of silicon oxide and the carbon source containing a carbohydrate can also be carried out directly in the high-temperature range, in which case the reaction participants produced in gaseous form or process gases have to be able to leave the reaction zone readily. This can be ensured by a loose bed or a bed containing shaped bodies of silicon oxide and/or the carbon source or preferably shaped bodies comprising silicon dioxide and the carbon source (carbohydrate). As gaseous reaction products or process gases, it is possible for, in particular, water vapour, carbon monoxide and downstream products to be formed. At high temperatures, in particular in the high-temperature range, predominantly carbon monoxide is formed.

Possible reactors for use in the process of the invention are all reactors known to those skilled in the art for pyrolysis and/or calcination. The pyrolysis and subsequent calcination to form SiC and, if appropriate, for graphitization can therefore be carried out using all laboratory reactors, pilot plant reactors or preferably industrial reactors known to those skilled in the art, for example a rotary tube reactor or a microwave reactor as is known for the sintering of ceramics.

The microwave reactors can be operated in the high-frequency (HF) range; for the purposes of the present invention, the high-frequency range is from 100 MHz to 100 GHz, in particular from 100 MHz to 50 GHz or from 100 MHz to 40 GHz. Preferred frequency ranges are from about 1 MHz to 100 GHz, with from 10 MHz to 50 GHz being particularly preferred. The reactors can be operated in parallel. Particular preference is given to using magnetrons at 2.4 MHz for the process.

The high-temperature reaction can also be carried out in conventional melting furnaces for the production of steel or silicon, e.g. metallurgical silicon, or other suitable melting furnaces, for example induction furnaces. The construction of such melting furnaces, particularly preferably electric furnaces which use an electric arc as energy source, is adequately known to those skilled in the art and is not part of the present patent application. In the case of DC furnaces, these have a melting electrode and a bottom electrode, while AC furnaces usually have three melting electrodes. The length of the electric arc is regulated by means of an electrode regulator. The electric arc furnaces are generally based on a reaction chamber made of refractory material. The raw materials, in particular the pyrolysed carbohydrate on silica/SiO₂, are introduced in the upper region, in which the graphite electrodes for producing the electric arc are also located. These furnaces are usually operated at temperatures in the region of 1800° C. In addition, a person skilled in the art will know that the furnace structures themselves must not contribute to contamination of the silicon carbide prepared.

The invention also provides a composition comprising silicon carbide optionally together with a carbon matrix and/or silicon oxide matrix or a matrix comprising silicon carbide, carbon and/or silicon oxide and also possibly silicon, which can be obtained by the process of the invention, in particular by the calcination step, and is, in particular, isolated. Isolation means that, after carrying out the process, the composition and/or the high-purity silicon carbide is obtained and isolated, in particular as product. Here, the silicon carbide can be provided with a passivation layer, for example a layer containing SiO₂.

This product can then serve as reaction participant, catalyst, material for producing articles, for example filters, shaped or green bodies, and can also be utilized in further applications with which a person skilled in the art will be familiar. A further important application is use of the composition comprising silicon carbide as reaction starter and/or reaction participant and/or in the production of electrode material or in the preparation of silicon carbide from sugar charcoal and silica.

The invention also provides the pyrolysis and, if appropriate, calcination product, in particular a composition which can be obtained by the process of the invention and, in particular, the pyrolysis and/or calcination product which is isolated from the process and has a content of carbon to silicon oxide, in particular silicon dioxide, of from 400:0.1 to 0.4:1000.

The conductivity of the process products, in particular the high-density pressed pulverulent process products, measured between two pointed electrodes is preferably in the range κ[m/ω.m²]=1·10⁻¹ to 1·10⁻⁶. A low conductivity, which correlates directly with the purity of the process product, is sought for the respective silicon carbide process product.

The composition or the pyrolysis and/or calcination product preferably has a graphite content of from 0 to 50% by weight, preferably from 25 to 50% by weight, based on the total composition. According to the invention, the composition or the pyrolysis and/or calcination product has a proportion of silicon carbide of from 25 to 100% by weight, in particular from 30 to 50% by weight, based on the total composition.

The invention also provides a silicon carbide having a carbon matrix comprising pyrolysis carbon and/or carbon black and/or graphite or mixtures of these and/or having a silicon oxide matrix comprising silicon dioxide, silica and/or mixtures of these or having a mixture of the abovementioned components, which can be obtained by the process of the invention, in particular as set forth in any of Claims 1 to 10. In particular, the SiC is isolated and used further, as described below.

The total content of the elements boron, phosphorus, arsenic and/or aluminium is preferably below 10 ppm by weight in silicon carbide corresponding to the definition of the invention.

The invention also provides a silicon carbide optionally having proportions of carbon and/or proportions of silicon oxide or mixtures comprising silicon carbide, carbon and/or silicon oxide, in particular silicon dioxide, having a total content of the elements boron, phosphorus, arsenic and/or aluminium of less than 100 ppm by weight in silicon carbide. The impurity profile of the high-purity silicon carbide in respect of boron, phosphorus, arsenic, aluminium, iron, sodium, potassium, nickel, chromium is preferably from <5 ppm to 0.01 ppt (by weight), in particular from <2.5 ppm to 0.1 ppt. The silicon carbide optionally having carbon and/or Si_{y}O_{z} matrices which is obtained by the process of the invention particularly preferably has an impurity profile as defined above in respect of the elements B, P, Na, S, Ba, Zr, Zn, Al, Fe, Ti, Ca, K, Mg, Cu, Cr, Co, Zn, Ni, V, Mn and/or Pb and also mixtures of these elements.

In particular, the silicon carbide which can be obtained has an overall content of carbon to silicon oxide, in particular silicon dioxide, of from 400:0.1 to 0.4:1000, and preferably has, in particular in the case of the composition, a graphite content of from 0 to 50% by weight, particularly preferably from 25 to 50% by weight. The proportion of silicon carbide is, in particular, in the range from 25 to 100% by weight, preferably from 30 to 50% by weight in the silicon carbide (total) according to the above definition.

In one embodiment, the invention provides for the use of silicon carbide or a composition or a pyrolysis and/or calcination product of the process of the invention, in particular as set forth in any of Claims 1 to 13, in the production of silicon, in particular in the production of solar silicon. The invention provides, in particular, for use in the production of solar silicon by reduction of silicon dioxide at high temperatures and/or in the preparation of silicon carbide by reaction of pyrolysis carbon, in particular sugar charcoal and silicon dioxide, in particular a silica, preferably a pyrogenic or precipitated silica or SiO₂ which may have been purified by means of ion exchangers, at high temperatures, as abrasive, insulator, as refractory, e.g. as heat-resistant tile, or in the production of articles or in the production of electrodes.

The invention also provides for the use of silicon carbide or a composition or a pyrolysis and/or calcination product which can be obtained by the process of the invention, in particular as set forth in any of Claims 1 to 13, as catalyst, especially in the production of silicon, in particular in the production of solar silicon, more particularly in the production of solar silicon by reduction of silicon dioxide at high temperatures, and also, if appropriate, in the preparation of silicon carbide for semiconductor applications or for use as catalyst in the production of very high-purity silicon carbide, for example by sublimation, or as reactant in the production of silicon or in the preparation of silicon carbide, in particular from pyrolysis carbon, preferably from sugar charcoal and silicon dioxide, preferably silica, at high temperatures, or for use as material of articles or as electrode material, in particular for electrodes of electric arc furnaces. The use as material of articles, in particular electrodes, encompasses the use of the material as material for the articles or else the use of further-processed material for producing the article, for example sintered material or abrasives.

The invention further provides for the use of at least one carbohydrate in the preparation of silicon carbide, in particular silicon carbide which can be isolated as product, or a composition containing silicon carbide or a pyrolysis and/or calcination product containing silicon carbide, especially in the presence of silicon oxide, preferably in the presence of silicon oxide and/or silicon dioxide.

According to the invention, a selection from at least one carbohydrate and a silicon oxide, in particular a silicon dioxide, especially without further components, is used for preparing silicon carbide, with the silicon carbide, a composition containing silicon carbide, or a pyrolysis and/or calcination product being isolated as reaction product.

The invention also provides a composition, in particular formulation, or a kit comprising at least one carbohydrate and silicon oxide, in particular for use in the process of the invention or for the use according to the invention, in particular as set forth in any of Claims 1 to 10, or for use according to Claim 16. The invention thus also provides a kit containing separate formulations, in particular in separate containers such as vessels, bags and/or cans, in particular in the form of an extrudate and/or powder of silicon oxide, in particular silicon dioxide, optionally together with pyrolysis products of carbohydrates on SiO₂ and/or the carbon source comprising at least one carbohydrate, in particular for use according to the descriptions given above. It can be preferred that the silicon oxide is present directly with the carbon source comprising a carbohydrate, for example impregnated therewith or the carbohydrate supported on SiO₂, etc., in the form of tablets, as granules, extrudate, in particular as pellet, in one container in the kit and, if appropriate, further carbohydrate and/or silicon oxide is present as powder in a second container.

The invention further provides an article, in particular a green body, shaped body, sintered body, electrode, heat-resistant component, comprising a silicon carbide according to the invention or a composition according to the invention containing silicon carbide, in particular as set forth in any of Claims 1 to 13, and also, if appropriate, further customary auxiliaries, additives, processing aids, pigments or binders. The invention thus provides an article containing a silicon carbide according to the invention or an article produced using the silicon carbide according to the invention, in particular as set forth in any of Claims 1 to 13.

The following examples illustrate the process of the invention without the invention being restricted to these examples.

### COMPARATIVE EXAMPLE 1

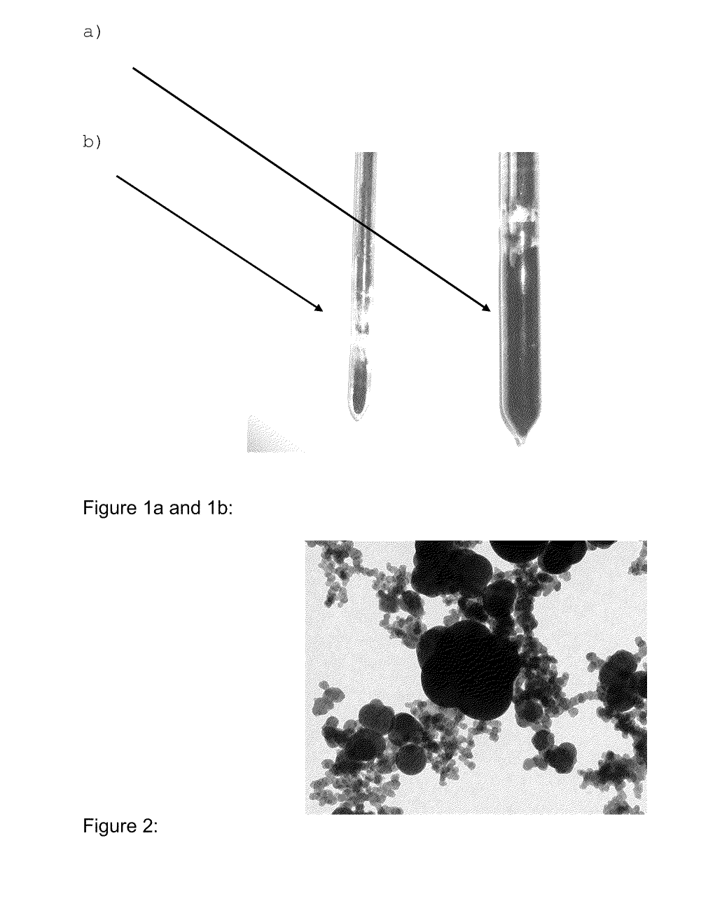

Commercial refined sugar was melted in a fused silica test tube and subsequently heated to about 1600° C. The reaction mixture foams strongly on heating and partly escapes from the fused silica test tube. Caramel formation is observed at the same time. The pyrolysis product formed adheres to the wall of the reaction vessel (FIG. 1a).

### EXAMPLE 1A

Commercial refined sugar was mixed with SiO₂ (Sipernat® 100) in a weight ratio of 1.25:1, melted and heated to about 800° C. Caramel formation is observed, but foaming does not occur. A graphite-containing, particulate pyrolysis product which, in particular, does not adhere to the wall of the reaction vessel is obtained (FIG. 1b). FIG. 2 is a micrograph of the pyrolysis product from Example 1a.

The pyrolysis product has distributed itself on and presumably also in the pores of the SiO₂ particles. The particulate structure is retained.

### EXAMPLE 1B

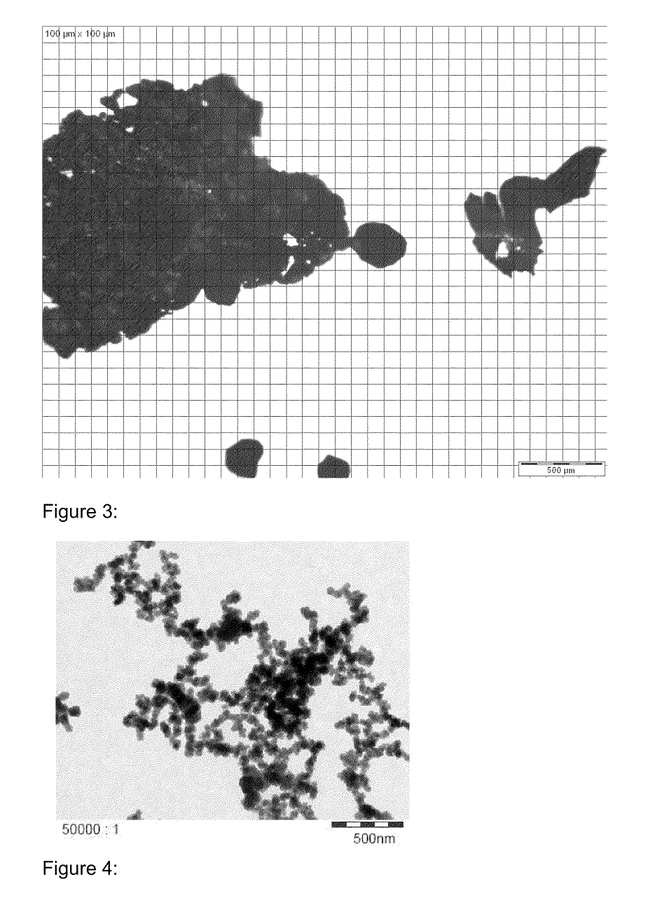

Commercial refined sugar was mixed with SiO₂ (Sipernat® 100) in a weight ratio of 5:1, melted and firstly heated to about 800° C. and subsequently heated further to about 1800° C. Caramel formation is observed but foaming does not occur. A silicon carbide containing proportions of graphite is obtained. FIGS. 3 and 4 are micrographs of two samples of the calcination product. The formation of silicon carbide was able to be confirmed by means of XPS spectra and determination of the bond energies. Furthermore, Si—O structures could be detected. The formation of graphite was concluded from the metallic sheen under an optical microscope.

### EXAMPLE 2

A finely particulate formulation of sugar applied to SiO₂ particles is reacted at elevated temperature in a rotary tube furnace containing SiO₂ spheres for heat distribution. The formulation was prepared, for example, by dissolution of sugar in an aqueous silicic acid solution with subsequent drying and, if necessary, homogenization. Residual moisture was still present in the system. About 1 kg of the formulation was used. The residence time in the rotary tube furnace depends on the water content of the finely particulate formulation. The rotary tube furnace was equipped with a preheating zone for drying of the formulation, and the formulation subsequently passed through a pyrolysis and calcination zone having temperatures of from 400° C. to 1800° C. The residence time encompassing the drying step, pyrolysis and calcination step was about 17 hours. During the entire process, the process gases formed, e.g. water vapour and CO, could be removed in a simple manner from the rotary tube furnace.

The SiO₂ used had a content of boron of less than 0.1 ppm, of phosphorus of less than 0.1 ppm and an iron content of less than about 0.2 ppm. The iron content of the sugar before formulation was determined as less than 0.5 ppm.

After pyrolysis and calcination, the contents were redetermined, with the content of boron and phosphorus being found to be less than 0.1 ppm and the content of iron having increased to 1 ppm. The increased iron content can only be explained by the product having come into contact with parts of the furnace which are contaminated with iron.

### EXAMPLE 3

Example 2 was repeated with the laboratory rotary tube furnace being coated beforehand with high-purity silicon carbide. This was reacted with SiO₂ spheres for heat distribution and with a finely particulate formulation containing sugar applied to SiO₂ particles at elevated temperature. The formulation was, for example, prepared by dissolution of sugar in an aqueous silicic acid solution with subsequent drying and, if necessary, homogenization. Residual moisture was still present in the system. About 10 g of the formulation were used.

The residence time in the rotary tube furnace depends on the water content of the finely particulate formulation. The rotary tube furnace was equipped with a preheating zone for drying of the formulation, and the formulation subsequently passed through a pyrolysis and calcination zone having temperatures of from 400° C. to 1800° C. The residence time encompassing the drying step, pyrolysis and calcination step was about 17 hours. During the entire process, the process gases formed, e.g. water vapour and CO, could be removed in a simple manner from the rotary tube furnace.

The SiO₂ used had a content of boron of less than 0.1 ppm, of phosphorus of less than 0.1 ppm and an iron content of less than about 0.2 ppm. The iron content of the sugar before formulation was determined as less than 0.5 ppm.

After pyrolysis and calcination, the contents were redetermined, with the content of boron and phosphorus being found to be less than 0.1 ppm and the content of iron continuing to be below 0.5 ppm.

### EXAMPLE 4

In an electric arc furnace, a finely particulate formulation of pyrolysed sugar on SiO₂ particles is reacted at elevated temperature. The formulation of pyrolysed sugar was prepared beforehand by pyrolysis in a rotary tube furnace at about 800° C. About 1 kg of the finely particulate pyrolysed formulation was used.

During the reaction in the electric arc furnace, the process gas CO formed can easily escape through the voids formed by the particulate structure of the SiO₂ particles and be removed from the reaction space. As electrodes, use was made of high-purity graphite electrodes and high-purity graphite was likewise utilized for lining the bottom of the reactor. The electric arc furnace was operated at from 1 to 12 kW. After the reaction, high-purity silicon carbide containing proportions of graphite, i.e. in a carbon matrix, was obtained.

The SiO₂ used had a content of boron of less than 0.17 ppm, of phosphorus of less than 0.15 ppm and an iron content of less than about 0.2 ppm. The iron content of the sugar before formulation was determined as less than 0.7 ppm.

After pyrolysis and calcination, the contents in the silicon carbide were redetermined, with the content of boron and phosphorus continuing to be below 0.17 ppm and below 0.15 ppm, respectively, and the content of iron continuing to be below 0.7 ppm.

### EXAMPLE 5

A reaction of a pyrolysed formulation analogous to Example 3 was carried out in a microwave reactor. For this purpose, about 0.1 kg of a dry, finely particulate formulation of pyrolysed sugar on SiO₂ particles was reacted at frequencies above 1 gigawatt to form silicon carbide in a carbon matrix. The reaction time depends directly on the power introduced and the reactants.

When a reaction starting from carbohydrates and SiO₂ particles is carried out, the reaction times are correspondingly longer.

1. Process for preparing silicon carbide by reaction of silicon oxide and a carbon source comprising at least one carbohydrate at elevated temperature.

2. Process according to claim 1, wherein the silicon carbide is isolated together with a carbon matrix or silicon oxide matrix or a combination thereof, or a matrix comprising carbon or silicon oxide or a combination thereof.

3. Process according to claim 1, wherein the silicon carbide has a high purity.

4. Process according to claim 1, wherein the carbon source comprises a carbohydrate mixture.

5. Process according to claim 1, wherein the carbon source comprises a crystalline sugar.

6. Process according to claim 1, wherein the silicon oxide comprises a silicon dioxide.

7. Process according to claim 1, wherein the molar ratio of the carbon content of the carbon source to the silicon content of the silicon oxide is from 1000:0.1 to 0.1:1000 based on the total composition.

8. Process according to claim 1, wherein the reaction is carried out in the temperature range from 150° C. to 3000° C.

9. Process according to claim 1, wherein essentially a pyrolysis is carried out in a first phase and essentially a calcination is carried out in a second phase.

10. Process according to claim 1, wherein the process is carried out in the range from 1 mbar to 50 bar.

11. Composition comprising silicon carbide optionally together with a carbon matrix or silicon oxide matrix or a combination thereof, or a matrix comprising silicon carbide, carbon or silicon oxide or a combination thereof, produced according to claim 1.

12. Pyrolysis and optionally calcination product having a content of carbon to silicon oxide of from 400:0.1 to 0.4:1000.

13. Silicon carbide optionally together with an amount of carbon or an amount of silicon oxide or a combination thereof, or mixtures comprising silicon carbide, carbon or silicon oxide or a combination thereof, having a total content of the elements boron, phosphorus, arsenic or aluminium, or any combination thereof, of less than 10 ppm by weight in the silicon carbide.

14.-16. (canceled)

17. Composition or kit comprising at least one carbohydrate and silicon oxide for the process according to claim 1.

18. Articles selected from green bodies, shaped bodies, sintered bodies, electrodes, and heat-resistant components, comprising a silicon carbide, pyrolysis product or calcination product, or a combination thereof, or a composition according to claim 11 and optionally further auxiliaries, additives, processing aids, pigments or binders.

19. Article of manufacture comprising silicon carbide produced according to the process of claim 1, selected from solar silicon, an abrasive, a refractory, an insulator or an electrode.

20. Catalyst or reactant for the production of silicon or silicon carbide, comprising silicon carbide produced according to the process of claim 1.

21. Process according to claim 6, wherein the silicon dioxide comprises a pyrogenic or precipitated silica or a silica gel.

22. Process according to claim 21, wherein the pyrogenic or precipitated silica or silica gel is of high or very high purity.

23. Process according to claim 10, wherein the pyrolysis is carried out at from 1 mbar to 50 bar, or the calcination is carried out at from 1 mbar to 1 bar, or a combination thereof.
